(19) United States
(12) Patent Application Publication
(10) Pub. No.: US 2026/0363478 A1
(43) Pub. Date: Nov. 19, 2026

(54) STABLY-HUNG DUAL-PURPOSE COFFEE DRIP BAG STRUCTURE

(71) Applicants: CHAN-LIANG WANG, New Taipei City (TW); MING-SHENG CHEN, New Taipei City (TW); MING-YANG CHEN, New Taipei City (TW)

(72) Inventors: CHAN-LIANG WANG, New Taipei City (TW); MING-SHENG CHEN, New Taipei City (TW); MING-YANG CHEN, New Taipei City (TW)

(21) Appl. No.: 19/121,949

(22) PCT Filed: Oct. 18, 2022
(86) PCT No.: PCT/CN2022/125856

§ 371 Date: Apr. 17, 2025

(51) Int. Cl. A47J 31/08

(52) U.S. Cl. CPC A47J 31/08

(57) ABSTRACT

The present invention relates to a stably-hung dual-purpose coffee drip bag structure, comprising a filter bag and a hanger device respectively arranged on two sides of the filter bag. The hanger device has a first fixing part inside, a connecting part extending upward from the first fixing part, an outwards-pulling part extending above the connecting part, and the outwards-pulling part is adjacent to the connecting part to form a upright hanging recess. An upper hanging piece is respectively provided at the two end corners above the outwards-pulling part, and a lower oblique-hanging piece is respectively provided at the two end corners below the outwards-pulling part. An upper hanging recess is formed between the upper hanging piece and the outwards-pulling part, and a lower obliquely-hanging recess is formed between the lower oblique-hanging piece and the outwards-pulling part. The upright hanging recess is used for upright hanging on the rim, and the hanging recess is in cooperation with the lower oblique hanging recess diagonally opposite to the upper hanging groove for oblique hanging on the rim.

### TECHNICAL FIELD

The present invention relates to a stably-hung dual-purpose coffee drip bag structure, which is hung on a container for extracting coffee, and more particularly to a filter hanging structure that can be fixed on the container in a upright hanging or oblique hanging manner according to different needs, allowing the user to select the coffee extraction mode.

BACKGROUND ART

Filter-type/hanger-type coffee mainly uses filter paper to hold ground coffee powder, and it is hung on the mouth of the cup, allowing users to add hot water to brew it themselves, so as to extract the charming flavor and aroma of the coffee and achieve the purpose of tasting coffee.

The existing filter-type/hanger-type coffee is made into a slightly square filter bag or a funnel-shaped filter bag according to the extraction method. The flavors presented are also completely different according to the extraction time and method. The brewing methods of square filter bag and funnel filter bag are explained as follows:
(1) A slightly square filter bag: There is a water inlet on the top. The hanger is hung on the mouth of a cup, so that the water inlet on the top of the filter bag can be opened to allow hot water to be added to brew the coffee powder. Since the bottom of the filter bag is long, the contact time between the coffee powder and the hot water can be extended. The user can control the contact time between the hot water and the coffee powder to extract coffee with full flavors and aromas and different concentrations;
(2) Funnel-shaped filter bag: The water inlet at the top is larger than that at the bottom. The brewed coffee liquid will fall directly into the cup, greatly shortening the contact time between hot water and coffee powder, so as to achieve the purpose of quickly extracting coffee in a short period of time, making the coffee taste more refreshing.

However, existing commercially available filter coffee products have already been formulated in filter bag form. No matter which type of filter bag a user purchases, the user can only brew coffee according to the purchased filter bag form and cannot change the brewing mode of the filter bag.

Therefore, the inventors began to research and develop a drip bag structure that can be used for both upright hanging and oblique hanging. Please refer to FIG. 13, which is a first-generation product. The hanger sheet 4 of the first generation is cut with a detachable inner ring part 41 in the middle. The four end corners of the inner edge of the inner ring part 41 are respectively provided with the upper slot 42 on the upper side and the lower slot 43 on the lower side. Please refer to FIG. 14. The two upper slots 42 can be used to hang upright on the rim 31 of the cup 3. Please refer to FIG. 15. One of the upper slots 42 co-operates with the obliquely opposite lower slot 43 to be hung obliquely on the rim 31. Since the upper slot 42 and the lower slot 43 of this model are both arranged on the inner edge of the inner rim part 41, the inner ring part 41 limits the expansion of the upper slot 42 and the lower slot 43. Especially when hung obliquely, it can only be hung on the rim 31 of a cup 3 with smaller diameter.

Due to the shortcomings of the first generation for the oblique hanging, the inventors continued to improve and refine. Please refer to FIG. 16, which is a product of second generation. The hanger sheet 4′ of the second generation also cuts a detachable inner ring part 41′ in the middle. The inner ring part 41′ is provided with upper slot 42′ at the two upper end corners, and a lower slot 43′ is provided below the periphery of the hanger sheet 4′. Please refer to FIG. 17. When the cup is hung obliquely, one of the upper slots 42′ co-operates with the obliquely opposite lower slot 43′ to be hung obliquely on the rim 31. The lower slot 43′ is improved to the periphery to effectively solve the limitation of the inner ring part 41 when hanging. However, when the cup is hung obliquely and brewed, the force of the flushing water pulls the lower slot 43′, thereby deforming the filter bag and causing inconvenience in use.

### SUMMARY OF THE INVENTION

The present invention further improves the use of oblique hanging. The positions of the buckles are set on the outside of the detachable structure of the hanger sheet when oblique hanging, and are evenly set at four end corners. Therefore, when in use, the supporting force is evenly applied to avoid deformation of the filter bag, and the use efficiency is not affected by the diameter of the rim.

The stably-hung dual-purpose coffee drip bag structure of the present invention, in a simpler configuration, at least includes: a filter bag and a hanger device respectively arranged on both sides of the filter bag. Each hanger device has the upper hanging piece at the two end corners above and the lower obliquely-hanging piece at the two end corners below. Accordingly, the two upper hanging pieces and the two lower obliquely-hanging pieces are respectively located at the positions of four end corners outside of the hanger device. The upper hanging piece is used to hang directly on the rim of a cup, and the upper hanging piece can be in cooperation with the lower obliquely-hanging piece diagonally opposite to it for oblique hanging on the rim. Therefore, extraction can be carried out in different hanging ways according to different needs.

The stably-hung dual-purpose coffee drip bag structure of the present invention, in a delicate and complete configuration, at least includes: a filter bag and a hanger device respectively arranged on two sides of the filter bag. The filter bag has a chamber inside, a water inlet is arranged on the filter bag, and a side edge adjacent to the water inlet is set as a tearable edge. Each tearable edge is in a closed state under normal conditions and is torn open when in use. Each hanger device has a first fixing part inside, the first fixing part is fixedly arranged on two side surfaces of the filter bag, a connecting part extends upward from the first fixing part, and an outwards-pulling part extends above the connecting part, the outwards-pulling part is covered around the first fixing part and the connecting part, and an upper hanging piece is respectively provided at two end corners above the outer pulling part, a lower obliquely-hanging piece is respectively provided at two end corners below the outer pulling part, so that the two upper hanging pieces and the two lower obliquely-hanging pieces are respectively located at positions of four end corners outside the outwards-pulling part, an upper hanging groove is formed between the upper hanging piece and the outwards-pulling part, and a lower obliquely-hanging piece is formed between the lower oblique hanging piece and the outwards-pulling part.

In a preferred embodiment, the outwards-pulling part is adjacent to the connecting part to form a upright hanging recess, a first convex end is protruded outward on both sides of the connecting part, and a second convex end is protruded inward on both sides of the outwards-pulling part relative to each first convex end, each second convex end is arranged opposite to each first convex end. The upright hanging recess is adjacent to and between the first convex end and the second convex end. The first convex end and the second convex end are both arranged to be conical, and the conical edges of the first convex end and the second end are located on both sides below each upright hanging recess.

In a preferred embodiment, the outwards-pulling part is adjacent to the connecting part to form a upright hanging recess, and the outwards-pulling part extends away from an outer side of the upright hanging recess to have a protruding pull end.

In a preferred embodiment, the upper hanging piece has a joint segment connected to the outwards-pulling part, and an activity segment connected to the joint segment. The upper hanging recess is close to the joint segment, and the joint segment can be turned and folded so as to pull out the activity segment, thereby forming an opening between the activity segment and the outwards-pulling part, and the opening can be connected with the upper hanging recess.

In a preferred embodiment, the lower obliquely-hanging piece has a joint segment connected to the outwards-pulling part, and an activity segment connected to the joint segment. The lower obliquely-hanging recess is close to the joint segment, and the joint segment can be turned and folded so as to pull out the activity segment, thereby forming an opening between the activity segment and the outwards-pulling part, and the opening can be connected with the lower obliquely-hanging recess.

In a preferred embodiment, a second fixing part is provided around the outwards-pulling part, and the second fixing part is fixed to two side surfaces of the filter bag.

In a preferred embodiment, the second fixing part is further provided with a disconnecting part, a protruding pull end extends outwards from the outwards-pulling part, and the protruding pull end is located at the disconnecting part, so that a hand can quickly pull the protruding pull end.

In a preferred embodiment, the hanger device is a sheet cut with multiple cut lines, so that the sheet is formed with multiple first fixing part, the connecting part, the outwards-pulling part, each upper hanging piece and each lower obliquely-hanging piece that can be pulled, folded or unfolded along each cut line.

The outwards-pulling part is pulled outward so that the outwards-pulling part is involved in the connecting part, and the connecting part can pull out the first fixing part and the two side surfaces of the filter bag together. Accordingly, the space in the chamber can be opened. The two hanging recesses are used to be hung directly on the rim of a cup, and one of the hanging recesses is in cooperation with the lower obliquely-hanging recess diagonally opposite to it for obliquely hanging on the rim. Therefore, extraction can be performed in different hanging ways according to different needs.

### DESCRIPTION OF THE DRAWINGS

The present invention will be further described in detail below in association with the accompanying drawings and specific embodiments.

FIG. 1 is a schematic plan view of the overall structure of a first embodiment of a drip bag structure of the present invention;

FIG. 2 is a schematic plan view of the hanger structure of the first embodiment of the drip bag structure of the present invention;

FIG. 3 is a three-dimensional schematic diagram of performing folding on the hanger device of the first embodiment of the drip bag structure of the present invention;

FIG. 4 is a three-dimensional schematic diagram of performing a upright hanging of the first embodiment of the drip bag structure of the present invention;

FIG. 5 is a schematic plan view of performing a upright hanging of the first embodiment of the drip bag structure of the present invention;

FIG. 6 is a schematic plan view of performing an oblique hanging of the first embodiment of the drip bag structure of the present invention;

FIG. 7 is a partial cross-sectional schematic diagram of performing an oblique hanging of the first embodiment of the drip bag structure of the present invention;

FIG. 8 is a structural schematic plan view of the hanger device of the first embodiment of the drip bag structure of the present invention;

FIG. 9 is a structural schematic plan view of the hanger device of the second embodiment of the drip bag structure of the present invention;

FIG. 10 is a schematic plan view of performing a upright hanging of the second embodiment of the drip bag structure of the present invention;

FIG. 11 is a partial cross-sectional schematic diagram of performing a upright hanging of the second embodiment of the drip bag structure of the present invention;

FIG. 12 is a partial cross-sectional schematic diagram of performing an oblique hanging of the second embodiment of the drip bag structure of the present invention;

FIG. 13 is a schematic plan view of a first-generation product of an existing drip bag structure;

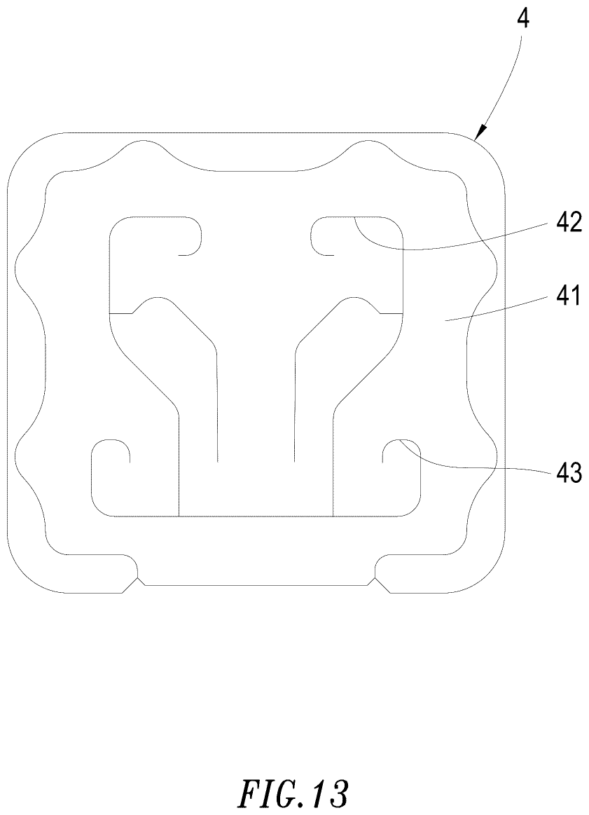

FIG. 14 is a schematic plan view of performing a upright hanging on the product of FIG. 13;

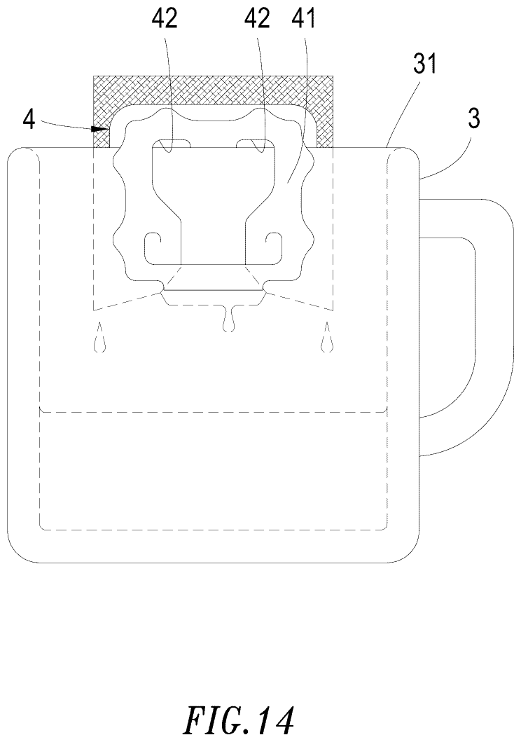

FIG. 15 is a schematic plan view of the product of FIG. 13 performing an oblique hanging;

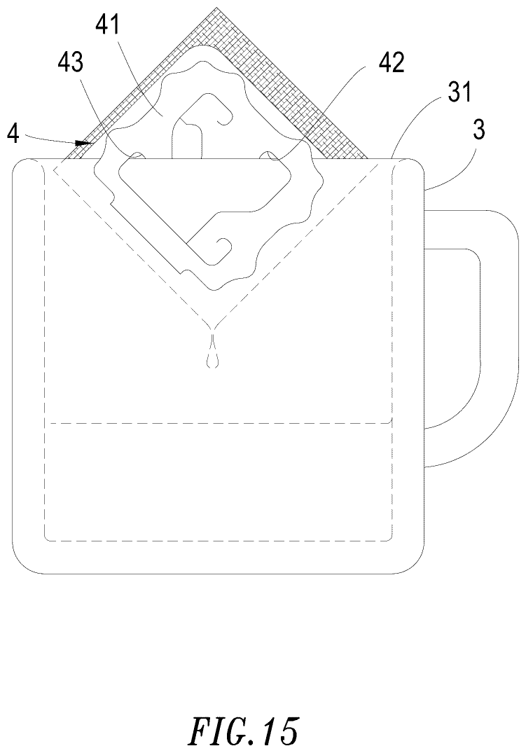

FIG. 16 is a schematic plan view of a second-generation product of an existing drip bag structure;

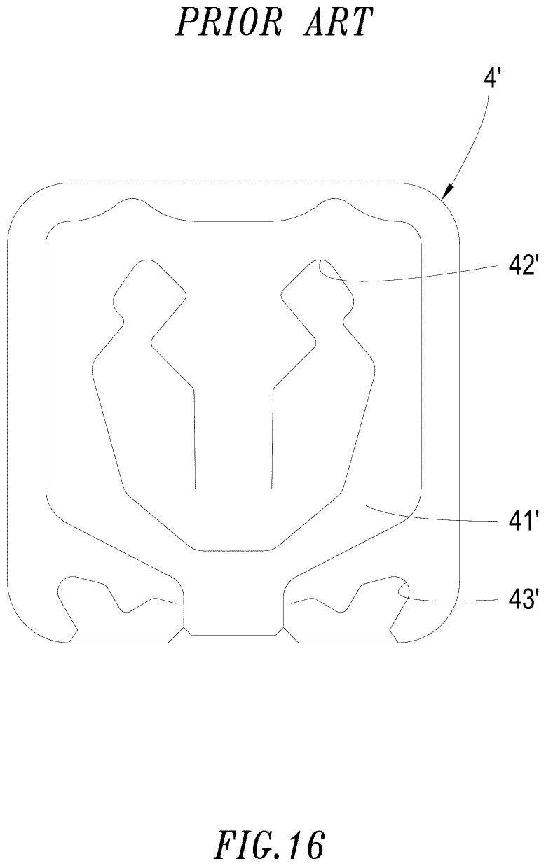

FIG. 17 is a schematic plan view of the product of FIG. 16 performing an oblique hanging.

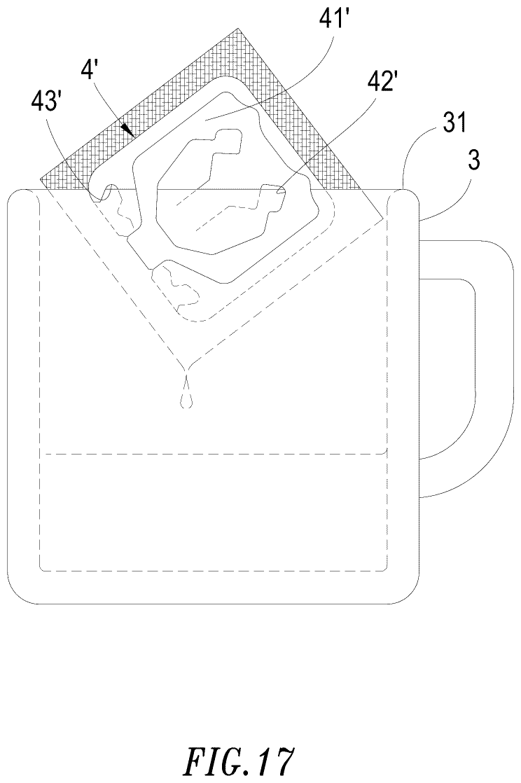

### REFERENCE EXPLANATIONS OF THE DRAWINGS

1: Filter bag;
11: Chamber;
12: Water inlet;
121: Sealing edge;
13: Tearable edge;
2: Hanger device;
20: Sheet;
201: Cut line;
21: First fixing part;
22: Connecting part;
221: First convex end;
23: Outwards-pulling part;
231: Second convex end;
232: Protruding pull end;
24: Upright hanging recess;
25: Upper hanging piece;
251: Joint segment;
252: Activity segment;
253: Opening;
26: Upper hanging recess;
27: Lower obliquely-hanging piece;
271: Joint segment;
272: Activity segment;
273: Opening;
28: Lower obliquely-hanging recess;
29: Second fixing part;
291: Disconnecting part;
3: Cup;
31: Rim;
4: Hanger sheet;
41: Inner ring part;
42: Upper slot;
43: Lower slot;
4′: Hanger sheet;
41′: Inner ring part;
42′: Upper slot;
43′: Lower slot.

### DETAILED EMBODIMENTS

The technical solutions in the embodiments of the present invention are described clearly and completely below in association with the accompanying drawings in the embodiments of the present invention. Many specific details are set forth in the following description in order to facilitate a full understanding of the present invention, but the present invention can also be implemented in other ways different from those described herein. Persons skilled in the art can make similar promotions without violating the connotations of the present invention, and thus the present invention is not limited by the specific embodiments disclosed hereinafter.

The terms “top”, “bottom”, “front”, “back”, “left”, “right”, and “side”, which are used to describe the names of the components, are disclosed in the contents of the specification of the present invention. The terms “top”, “bottom”, “front”, “back”, “left”, “right”, and “side” used to describe the names of the components are disclosed in the contents of the document to assist in the identification of the positional relationship between the plate structures, and the orientation of the actual product structure will vary with the angle of placement or the user. The direction of the actual product structure may change according to the angle of placement or the user's location, and cannot therefore limit the scope of equal coverage of the present invention.

As used herein, the terms “inside” and “interior” to describe the location of a structure refer to the central position close to the structure body, or a position that is not exposed in use; the term “inward” refers to the direction close to the structure body. The central position, or a position that is not exposed in use; the terms “outside” and “exterior” refer to the central position away from the structure body, or a position that is exposed in use; the terms “outward” refer to a position that is away from the structure body central location, or towards an exposed location in use.

As used herein, the term “away” to describe the location of a structure refers to a location that is further away between two target structures; the term “close” or “adjacent” refers to a position closer to the two target structures.

The terms “protruding”, “forming” or “extending” disclosed in the description of the present invention to describe the relationship between structural combinations generally refer to one structure being integrally combined with another structure.

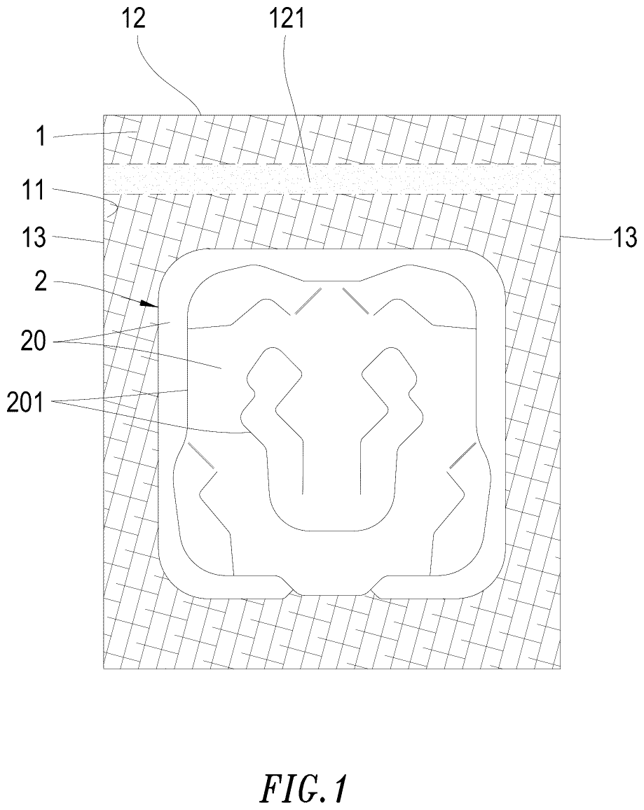

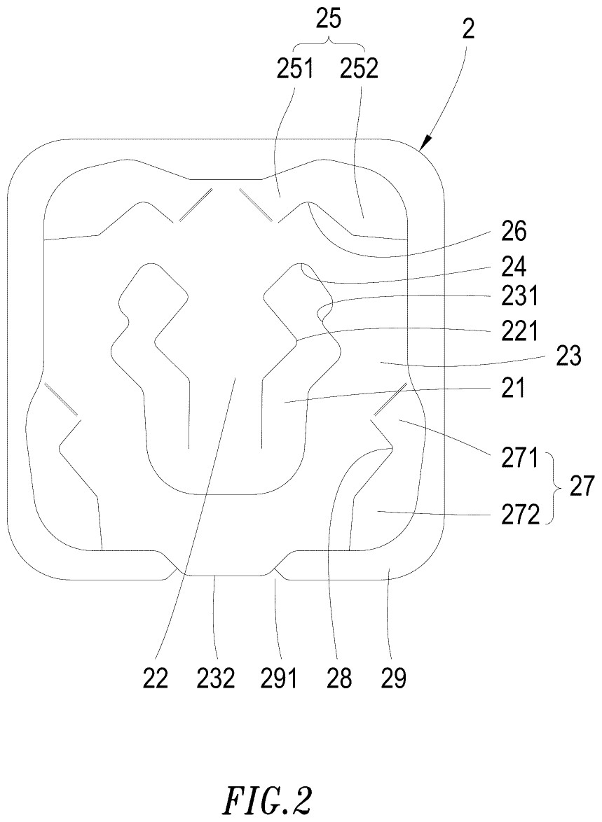

The stably-hung dual-purpose coffee drip bag structure of the present invention is shown in FIGS. 1 and 2, which is a first embodiment. As illustrated in the figure, it includes at least a filter bag 1 and a hanger device 2 respectively arranged on the two sides of the filter bag 1 (the two sides are symmetrical, and only one side is shown in the figure). The filter bag 1 is used to fill coffee brewing materials, and the hanger device 2 is used to be fixed on a container for holding coffee. When water is added to the filter bag 1, coffee can be brewed into the container.

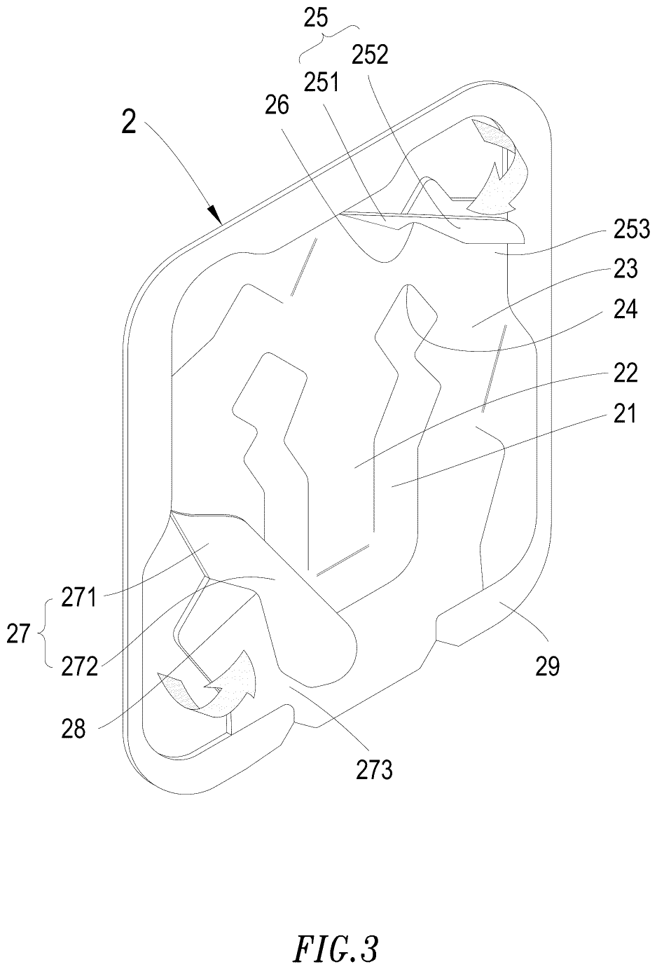

Please refer to FIGS. 1 to 3. The filter bag 1 has a chamber 11 therein. A water inlet 12 is provided on one side of the filter bag 1. The water inlet 12 has a tearable sealing edge 121. After the sealing edge 121 is torn, the water inlet 12 can be opened for use as a upright hanging. One or both adjacent sides of the water inlet 12 are set as a tearable edge 13. The tearable edge 13 is preferably sealed using a high frequency. Each tearable edge 13 is in a closed state under normal conditions. When in use, one of them can be torn open. The torn tearable edge 13 is connected with the water inlet 12 to form a larger opening for use as an oblique hanging.

The upright hanging and oblique hanging are used in association with the hanger device 2. Please refer to FIG. 1. The hanger device 2 is a sheet 20 cut with multiple cut lines 201, so that the sheet 20 forms multiple blocks that can be pulled, turned, folded or unfolded along each cut line 201, and different hanging effects of upright hanging or oblique hanging are implemented on the container for holding coffee according to each block.

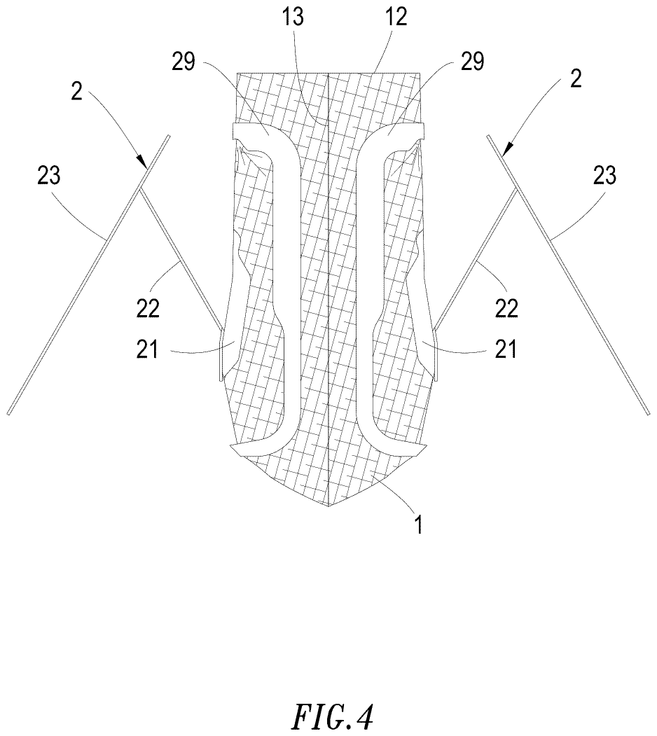

Please refer to FIGS. 2 to 4. The hanger device 2 has a first fixing part 21 inside. The first fixing part 21 is set to be U-shaped. A connecting part 22 extends from the inside of the first fixing part 21 from bottom to top. A first convex end 221 is protruded outward on both sides of the connecting part 22. An outwards-pulling part 23 extends above the connecting part 22. The outwards-pulling part 23 is covered around the first fixing part 21 and the connecting part 22. A second convex end 231 is protruded inward on both sides of the outwards-pulling part 23. Each second convex end 231 is relative to each first convex end 221. The outwards-pulling part 23 is adjacent to the connecting part 22 to form an incompletely-closed upright hanging recess 24, and the upright hanging recess 24 is adjacent to and between the first convex end 221 and the second convex end 231. Regarding the contour setting, the first convex end 221 and the second convex end 231 are both configured to be conical, and the conical edges of the first convex end 221 and the second convex end 231 are located on both sides below each upright hanging recess 24. The outwards-pulling part 23 extends a protruding pull end 232 away from the outer side of the upright hanging recess 24.

Please refer to FIGS. 2 to 4. The hanger device 2 further includes an upper hanging piece 25, an upper hanging recess 26, a lower obliquely-hanging piece 27 and a lower obliquely-hanging recess 28. The upper hanging piece 25 is located at the two end corners above the outwards-pulling part 23, and the lower obliquely-hanging piece 27 is located at the two end corners below the outwards-pulling part 23. Accordingly, the two upper hanging pieces 25 and the two lower obliquely-hanging pieces 27 are located respectively at the positions of four end corners outside the outwards-pulling part 23. The upper hanging piece 25 has a joint segment 251 connected to the outer outwards-pulling part 23, and a activity segment 252 connected to the joint segment 251. The upper hanging recess 26 is formed between the upper hanging piece 25 and the outwards-pulling part 23, and the upper hanging recess 26 is close to the joint segment 251. The joint segment 251 can be turned over or folded to pull out the activity segment 252, so that an opening 253 is formed between the activity segment 252 and the outwards-pulling part 23, and the opening 253 can be connected with the upper hanging recess 26. In addition, the lower obliquely-hanging piece 27 also has a joint segment 271 connected to the outwards-pulling part 23, and a activity segment 272 connected to the joint segment 271. The lower obliquely-hanging recess 28 is formed between the lower obliquely-hanging piece 27 and the outwards-pulling part 23, and the lower obliquely-hanging recess 28 is close to the joint segment 271. The joint segment 271 can be turned over or folded to pull out the activity segment 272, so that an opening 273 is formed between the activity segment 272 and the outwards-pulling part 23, and the opening 273 is connected with the lower obliquely-hanging recess 28.

Please refer to FIGS. 1 to 3. The hanger device 2 has a second fixing part 29 outside. The second fixing part 29 is further provided with a disconnecting part 291. The protruding pull end 232 is located at the disconnecting part 291 so that the protruding pull end 232 can be quickly pulled out by hand. The second fixing part 29 and the first fixing part 21 are both fixed (pasted) on the two sides of the filter bag 1. The second fixing part 29 is located around the outwards-pulling part 23, and is used to prevent the filter bag 1 from excessive deformation after being pulled open. After outwards pulling the outwards-pulling part 23, the outwards-pulling part 23 can be completely separated from the second fixing part 29, and is connected to the first fixing part 21 merely through the connecting part 22.

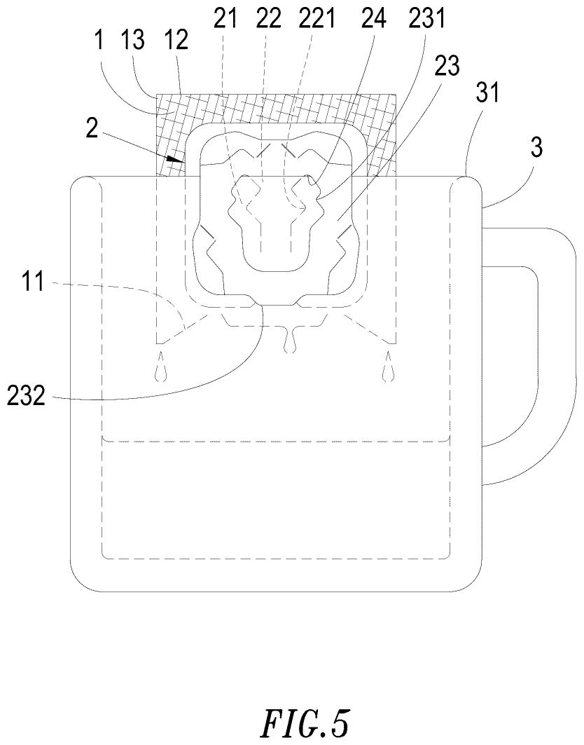

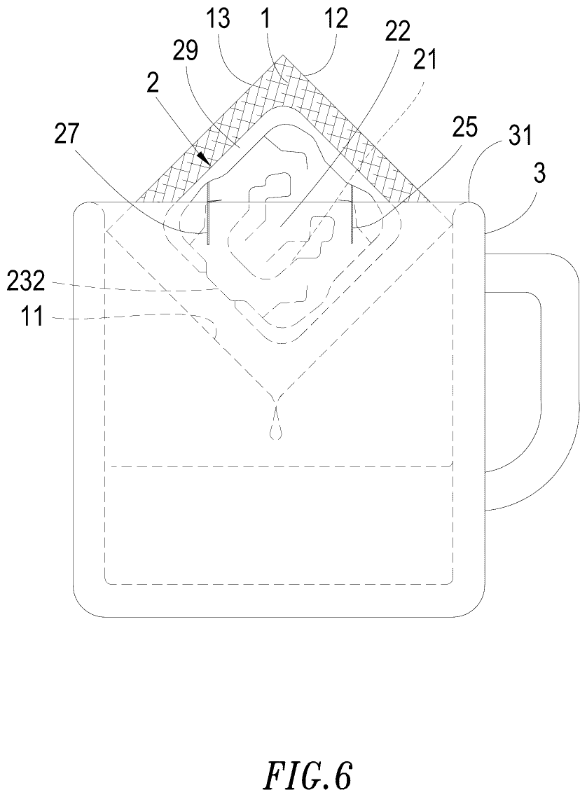

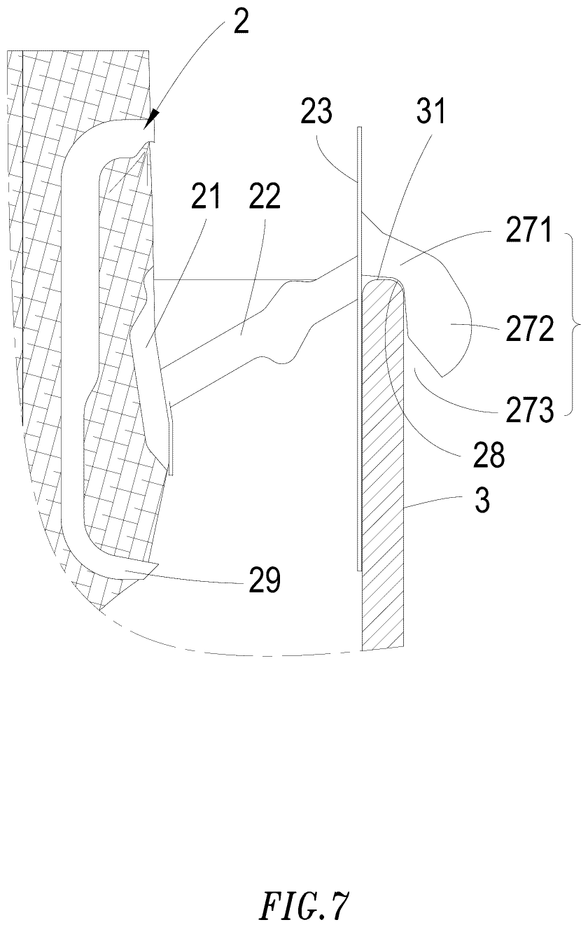

Please refer to FIGS. 1 to 4. When the first embodiment is implemented, the sealing edge 121 is torn open, and the protruding pull ends 232 on both sides are pulled outward, so that the outwards-pulling part 23 is separated from the second fixing part 29 and the first fixing part 21. The outwards-pulling part 23 is also involved in the connecting part 22. The connecting part 22 can pull out the first fixing part 21 and the two sides of the filter bag 1 together. Accordingly, the space inside the chamber 11 can be opened, and the filter bag 1 is hung on the rim 31 of a cup 3 through the hanger device 2. Different hanging methods can be provided according to different needs:
(1) Referring to FIGS. 2 to 5. The hanger device 2 is hung upright so that the rim 31 is snapped into the position of each upright hanging recess 24. The first convex end 221 and the second convex end 231 can be effectively clipped onto the rim 31. The filter bag 1 corresponds to water inlet 12 above the first fixing part 21 and faces upward. The extraction material (coffee powder) is poured into the chamber 11 through the water inlet 12 for extraction. This hanging method allows the coffee to be filtered out through the edge of the bottom of the filter bag 1.
(2) Please refer to FIGS. 2-3 and 6-7. The hanger device 2 is hung obliquely, one of the tearable edges 13 is torn open, the joint segment 251 of the upper hanging piece 25 away from the tearable edge 13 is folded over and the activity segment 252 is pulled out, and the lower obliquely-hanging piece 27 located at the diagonal angle (equivalent to the one close to the tearable edge 13) is also folded over the joint segment 271 and the activity segment 272 is pulled out. The torn tearable edge 13 is facing upward, and each opening 253 and 273 is inserted into the rim 31, so that the upper hanging recess 26 and the lower obliquely-hanging recess 28 are buckled with the rim 31, and the water inlet 12 and the torn tearable edge 13 are both facing obliquely upward to be connected with each other to present a larger opening. Therefore, the extraction material (coffee powder) is poured into the chamber 11 through the opening connected by the water inlet 12 and the tearable edge 13 for extraction. This hanging method allows the coffee to be filtered out through the tip where the two edge lines of the bottom of the filter bag 1 intersect.

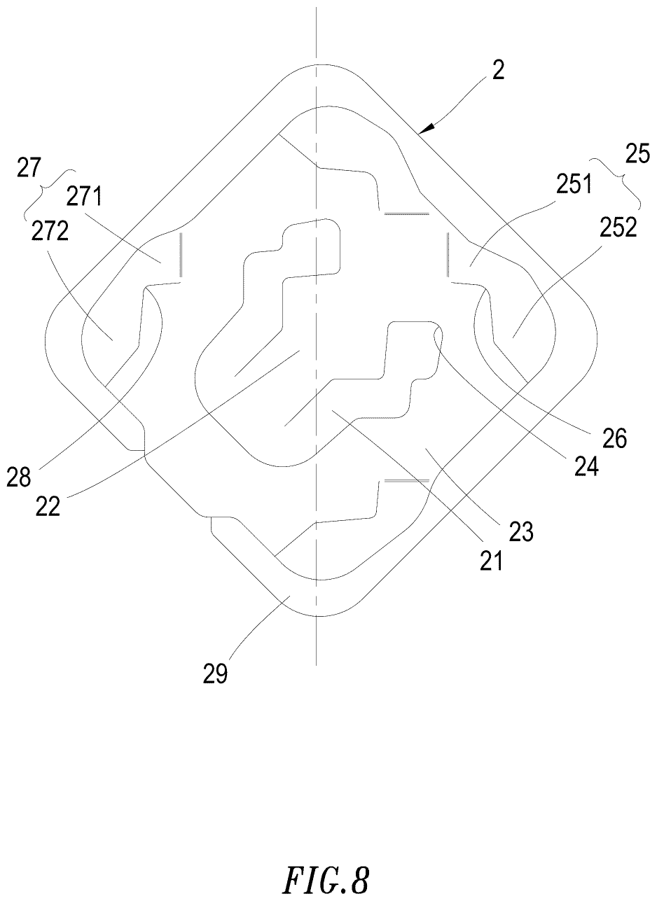

Please refer to FIGS. 2, 3 and 6. In this embodiment, the two upper hanging pieces 25 and the two lower obliquely-hanging pieces 27 are respectively located at the four end corners of the outwards-pulling part 23, and one side can be selected for use. Similarly, the upper hanging piece 25 and the lower obliquely-hanging piece 27 can also be made into a single one in manufacturing. Please refer to FIG. 8. In order to make the oblique hanging more stable, in the oblique hanging state (the hanger device 2 is tilted), the upper hanging recess 26 and the diagonally opposite lower obliquely-hanging recess 28 are symmetrically arranged to make the force uniform.

Please refer to FIGS. 1 to 8. The advantages of the present invention are:
(1) Since the coffee is filtered out through different paths, different flavors will be produced. In addition, each hanger device 2 can change the path of coffee being filtered out of the filter bag 1 through different hanging methods. Therefore, the user can freely choose the method of coffee filtering, which is more diverse in use;
(2) When used in an oblique manner, the upper hanging recess 26 and the lower obliquely-hanging recess 28 are both located at the four end corners outside the outwards-pulling part 23. Therefore, when in use, the supporting force is evenly distributed on the upper hanging piece 25 and the lower obliquely-hanging piece 27. If brewing water is poured into the chamber 11, the second fixing part 29 can prevent the filter bag 1 from being de-formed. The connecting part 22 has a buffering elasticity to prevent the flushing force from excessively pulling the upper hanging piece 25 and the lower obliquely-hanging piece bag 1, so as to provide a higher stability when in use.
(3) The upright hanging recess 24, the first outer snap-fit groove 26 and the second outer snap-fit groove 28 respectively have the first convex end 221, the second convex end 231, the third convex end 261 and the fourth convex end 281 to assist snapping on the rim 31, thereby achieving a better snapping effect.

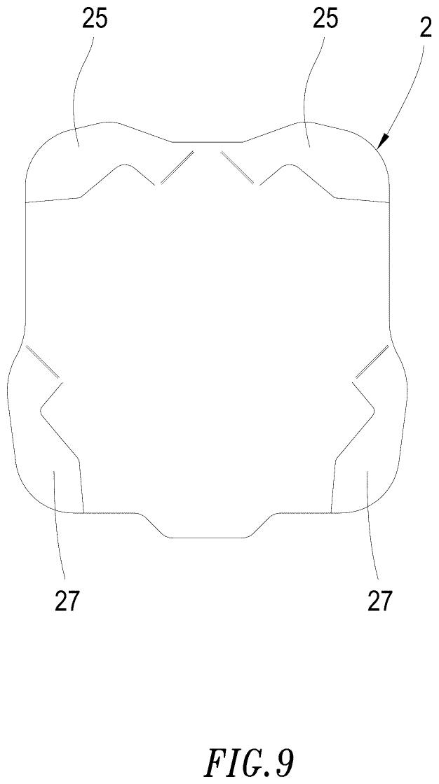

Please refer to FIG. 9 for the second embodiment of the stably-hung dual-purpose coffee drip bag structure of the present invention. As shown in the figure, the hanger device 2 of this embodiment has the upper hanging piece 25 at the two end corners above and the lower obliquely-hanging piece 27 at the two end corners below. Accordingly, the two upper hanging pieces 25 and the two lower obliquely-hanging pieces 27 are respectively located at the positions of four end corners outside of the hanger device 2, and the upper hanging piece 25 and the lower obliquely-hanging piece 27 can be turned over and folded.

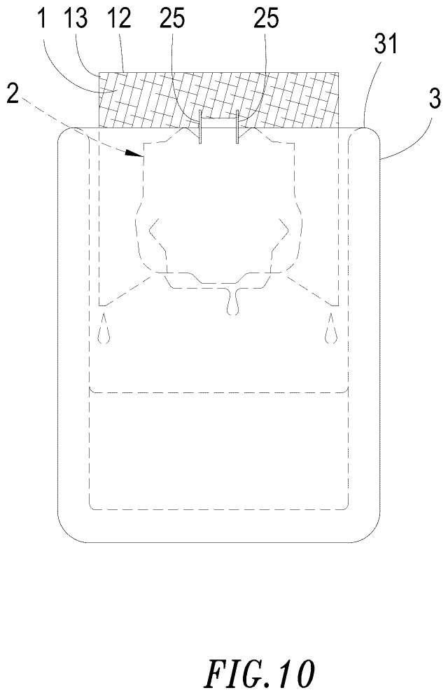

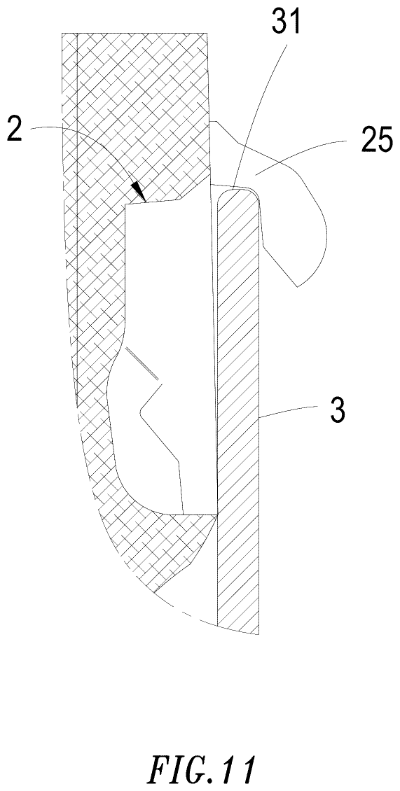

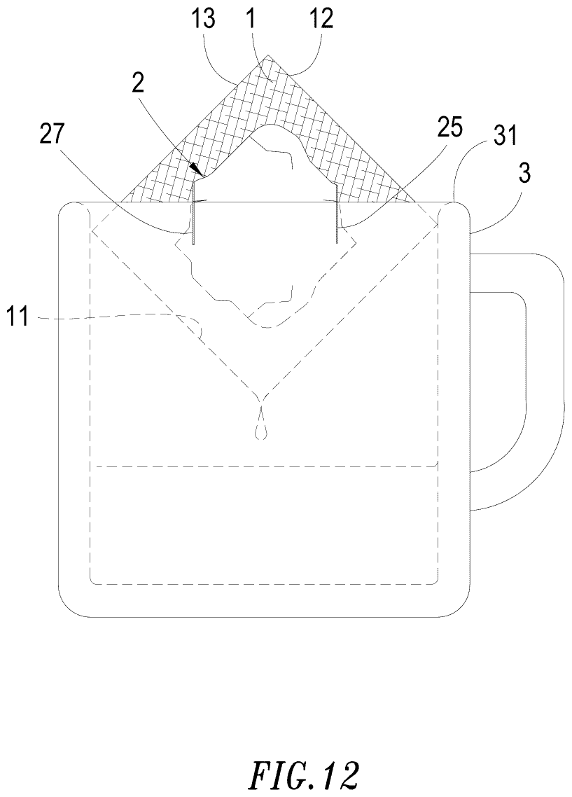

Please refer to FIGS. 10 and 11. The two upper hanging pieces 25 can be folded at the same time to effectively hook on the rim 31 for use as a upright hanging. Please refer to FIG. 12. The oblique hanging is the same as the first embodiment, through the diagonally opposite upper hanging piece 25 and the lower obliquely-hanging piece 27 to hook on the rim 31.

The above description is only a preferred embodiment of the present invention. Obviously, the described embodiment is only a part of the embodiment of the present invention, rather than all the embodiments. Based on the embodiment of the present invention, all other embodiment obtained by persons of ordinary skills in the are without making any creative work shall fall within the scope of protection of the present invention.

What is claimed is:

1. A stably-hung dual-purpose coffee drip bag structure, characterized in that, at least comprising:
a filter bag, wherein the filter bag has a chamber, the filter bag is provided with a water inlet, and a side edge adjacent to the water inlet is provided with a tearable edge, each tearable edge is in a closed state under normal conditions, and is torn open when in use; and
two hanger devices, fixedly arranged on two side surfaces of the filter bag, and each of two end corners above has an upper hanging piece, and each of two end corners below has a lower obliquely-hanging piece, so that the two upper hanging pieces and the two lower obliquely-hanging pieces are respectively located at positions of four end corners outside each hanger device.

2. A stably-hung dual-purpose coffee drip bag structure, characterized in that, at least comprising:
a filter bag, wherein the filter bag has a chamber, the filter bag is provided with a water inlet, and a side edge adjacent to the water inlet is provided with a tearable edge, each tearable edge is in a closed state under normal conditions, and is torn open when in use; and
two hanger devices, wherein each hanger device has a first fixing part inside, the first fixing part is fixedly arranged on two side surfaces of the filter bag, a connecting part extends upward from the first fixing part, and an outwards-pulling part extends above the connecting part, the outwards-pulling part is covered around the first fixing part and the connecting part, and an upper hanging piece is respectively provided at two end corners above the outer pulling part, a lower obliquely-hanging piece is respectively provided at two end corners below the outer pulling part, so that the two upper hanging pieces and the two lower obliquely-hanging pieces are respectively located at positions of four end corners outside the outwards-pulling part, an upper oblique hanging groove is formed between the upper hanging piece and the outwards-pulling part, and a lower obliquely-hanging piece is formed between the lower oblique hanging piece and the outwards-pulling part.

3. The stably-hung dual-purpose coffee drip bag structure according to claim 2, characterized in that, wherein a upright hanging recess is formed at the outwards-pulling part adjacent to the connecting part.

4. The stably-hung dual-purpose coffee drip bag structure according to claim 3, characterized in that, wherein a first convex end is protruded outward on both sides of the connecting part, and a second convex end is protruded inward on both sides of the outwards-pulling part relative to each first convex end, each second convex end is arranged opposite to each first convex end, and the upright hanging recess is adjacent to and between the first convex end and the second convex end.

5. The stably-hung dual-purpose coffee drip bag structure according to claim 4, characterized in that, wherein the first convex end and the second convex end are both configured to be conical, and conical edges of the first convex end and the second convex end are located on both sides below each upright hanging recess.

6. The stably-hung dual-purpose coffee drip bag structure according to claim 2, characterized in that, wherein the outwards-pulling part extends away from an outer side of the upright hanging recess to have a protruding pull end.

7. The stably-hung dual-purpose coffee drip bag structure according to claim 2, characterized in that, wherein the upper hanging piece has a joint segment connected to the outwards-pulling part, and an activity segment connected to the joint segment, the upper hanging recess is close to the joint segment, and the joint segment can be turned and folded so as to pull out the activity segment, thereby forming an opening between the activity segment and the outwards-pulling part, and the opening can be connected with the upper hanging recess.

8. The stably-hung dual-purpose coffee drip bag structure according to claim 2, characterized in that, wherein the lower obliquely-hanging piece has a joint segment connected to the outwards-pulling part, and an activity segment connected to the joint segment, the lower obliquely-hanging recess is close to the joint segment, and the joint segment can be turned and folded so as to pull out the activity segment, thereby forming an opening between the activity segment and the outwards-pulling part, and the opening can be connected with the lower obliquely-hanging recess.

9. The stably-hung dual-purpose coffee drip bag structure according to claim 2, characterized in that, wherein a second fixing part is provided around the outwards-pulling part, and the second fixing part is fixed to two side surfaces of the filter bag.

10. The stably-hung dual-purpose coffee drip bag structure according to claim 9, characterized in that, wherein the second fixing part is further provided with a disconnecting part, a protruding pull end extends outwards from the outwards-pulling part, and the protruding pull end is located at the disconnecting part, so that a hand can quickly pull the protruding pull end.
